(19) United States
(12) Patent Application Publication
(10) Pub. No.: US 2019/0123336 A1
(43) Pub. Date: Apr. 25, 2019

(54) SOLID-STATE RECHARGEABLE BATTERY HAVING FAST CHARGE SPEED

(71) Applicant: International Business Machines Corporation, Armonk, NY (US)

(72) Inventors: Joel P. de Souza, Putnam Valley, NY (US); Yun Seog Lee, Seoul (KR); Devendra K. Sadana, Pleasantville, NY (US)

(21) Appl. No.: 15/790,993

(22) Filed: Oct. 23, 2017

(51) Int. Cl. H01M 4/131; H01M 10/0525; H01M 10/058; H01M 4/136; H01M 4/525; H01M 4/505; H01M 4/58; H01M 4/04

(52) U.S. Cl. CPC H01M 4/131; H01M 10/0525; H01M 10/058; H01M 4/136; H01M 2004/021; H01M 4/505; H01M 4/5825; H01M 4/0426; H01M 4/525

(57) ABSTRACT

A solid-state rechargeable battery that has a fast charging speed and high-capacity is provided. In some embodiments, the solid-state rechargeable battery includes at least a cathode material layer that is composed of a cathode material that contains grains having a grain size of less than 100 nm, and a density of grain boundaries of 5 C or greater. In other embodiments, the cathode material layer is composed of a cathode material having a columnar microstructure.

### BACKGROUND

The present application relates to solid-state rechargeable battery technology. More particularly, the present application relates to a solid-state rechargeable battery that has a fast charge speed, and a high-capacity.

In recent years, there has been an increased demand for portable electronic devices such as, for example, computers, mobile phones, tracking systems, scanners, medical devices, smart watches, and fitness devices. One drawback with portable electronic devices is the need to include a power supply within the device itself. Typically, a battery is used as the power supply of such portable electronic devices. Batteries must have sufficient capacity to power the portable electronic device for at least the length that the device is being used. Sufficient battery capacity can result in a power supply that is quite heavy and/or large compared to the rest of the portable electronic device. As such, smaller sized and lighter weight power supplies with sufficient energy storage are desired. Such power supplies can be implemented in smaller and lighter weight portable electronic devices.

Another drawback of conventional batteries is that some of the batteries contain flammable and potentially toxic materials that may leak and may be subject to governmental regulations. As such, it is desired to provide an electrical power supply that is safe, solid-state and rechargeable over many charge/discharge life cycles; a rechargeable battery is a type of electrical battery which can be charged, discharged into a load, and recharged many times, while a non-rechargeable (or so-called primary battery) is supplied fully charged, and discarded once discharged.

One type of an energy-storage device that is small and light weight, contains non-toxic materials and that can be recharged over many charge/discharge cycles is a solid-state, lithium-based battery. Lithium-based batteries are rechargeable batteries that include two electrodes implementing lithium. In conventional lithium-based rechargeable batteries, the charging speed is typically from 0.8 C to 3 C, wherein C is the total battery capacity per hour. In such solid-state rechargeable batteries, the charging speed can be limited by the highly resistive cathode material, resistive electrolyte materials, resistive interfaces, and/or metallic lithium dendrite formation under large voltage biases.

There is a need for providing a solid-state rechargeable battery that has a fast charging speed and high-capacity.

### SUMMARY

A solid-state rechargeable battery that has a fast charging speed and high-capacity is provided. The term “solid-state” when used in conjunction with the term “battery” denotes a battery that is entirely composed of solid materials. As mentioned above, a rechargeable battery is a type of electrical battery which can be charged, discharged into a load, and recharged many times. The term “fast charging speed” is used throughout the present application to denote a battery that has a charge rate of 5 C or greater, wherein C is the total battery capacity per hour. The term “high-capacity” is used throughout the present application to denote a battery that has a capacity of 50 mAh/gm of cathode material or greater.

In some embodiments, the solid-state rechargeable battery includes at least a cathode material layer that is composed of a cathode material that contains grains having a grain size of less than 100 nm, and a density of grain boundaries of 10¹⁰ cm⁻² or greater. In other embodiments, the cathode material layer is composed of a cathode material having a columnar microstructure.

Notably, and in one embodiment, the solid-state rechargeable battery includes a cathode current collector, a cathode material layer located on a physically exposed surface of the cathode current collector and comprising grains having a grain size of less than 100 nm, and a density of grain boundaries of 10¹⁰ cm⁻² or greater, a solid-state electrolyte located on a physically exposed surface of the cathode material layer, an anode region located on the solid-state electrolyte, and an anode current collector located on the anode region.

In another embodiment, the solid-state rechargeable battery includes a cathode current collector, a cathode material layer located on a physically exposed surface of the cathode current collector and comprising a columnar microstructure, a solid-state electrolyte located on a physically exposed surface of the cathode material layer, an anode region located on the solid-state electrolyte, and an anode current collector located on the anode region.

### BRIEF DESCRIPTION OF SEVERAL VIEWS OF THE DRAWINGS

FIG. 1 is a cross-sectional view of a solid-state rechargeable battery in accordance with an embodiment of the present application.

FIG. 2 is a cross-sectional view of a solid-state rechargeable battery in accordance with another embodiment of the present application.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

The present application provides solid-state rechargeable batteries that have a fast charging speed and a high-capacity. The fast charge speed that is observed for the batteries of the present application is believed to be a result of providing a cathode material layer that contains small grains having a high density of grain boundaries, or a columnar microstructure. In such cathode material layers, grain boundaries are present in a sufficient quantity and direction which provide a means to efficiently and quickly diffuse cathode ions, such, as Li ions, therethrough. That is, the grain boundaries of the cathode material layers of the present application provide a substantially vertical pathway for cathode ion diffusion.

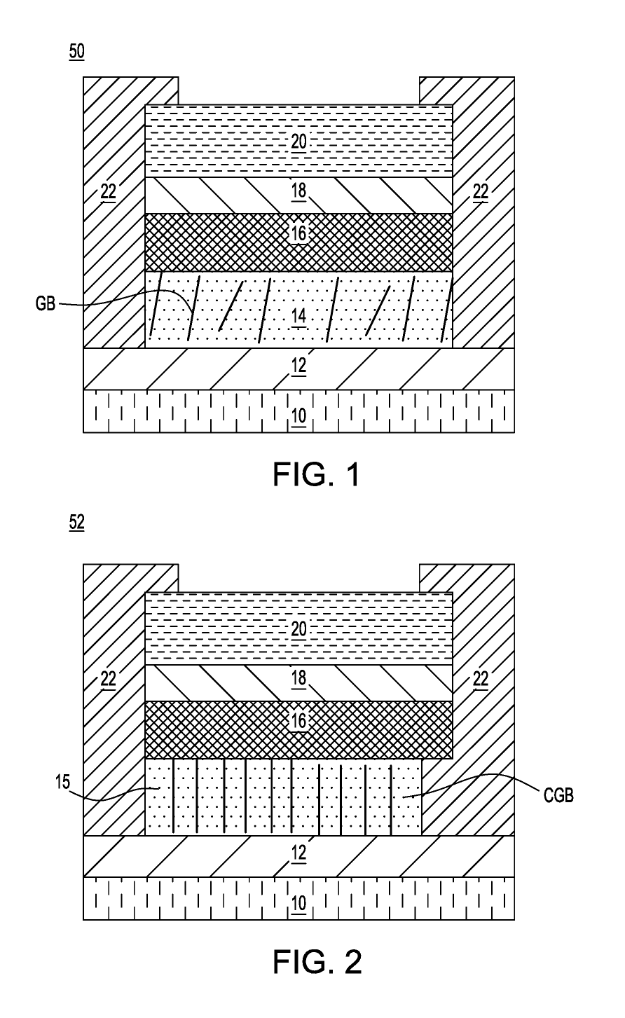

Referring first to FIG. 1, there illustrated a solid-state rechargeable battery 50 in accordance with an embodiment of the present application; the solid-state rechargeable battery is a thin film battery having a total thickness that is typically 100 μm or less. The solid-state rechargeable battery 50 of FIG. 1 includes from bottom to top, a substrate 10, a cathode current collector (or cathode-side electrode) 12, a cathode material layer 14, a solid-state electrolyte layer 16, an anode region 18, and an anode current collector (or anode-side electrode) 20. In some embodiments and as is illustrated in FIG. 1, the solid-state rechargeable battery 50 of the present application further includes a passivation layer 22 that surrounds a battery material stack of the cathode material layer 14, the solid-state electrolyte layer 16, the anode region 18, and the anode current collector 20. In this embodiment, the cathode material layer 14 is composed of a cathode material that contains grains having a grain size of less than 100 nm, and a density of grain boundaries of 10¹⁰ cm⁻² or greater.

Referring now to FIG. 2, there illustrated another solid-state rechargeable battery 52 in accordance with another embodiment of the present application; the solid-state rechargeable battery of FIG. 2 is also a thin film battery as defined above. The solid-state rechargeable battery 52 of FIG. 2 includes, from bottom to top, a substrate 10, a cathode current collector (or cathode-side electrode) 12, a cathode material layer 15, a solid-state electrolyte layer 16, an anode region 18, and an anode current collector (or anode-side electrode) 20. In some embodiments and as is illustrated in FIG. 2, the solid-state rechargeable battery 52 of the present application further includes a passivation layer 22 that surrounds a battery material stack of the cathode material layer 15, the solid-state electrolyte layer 16, the anode region 18, and the anode current collector 20. In this embodiment, the cathode material layer 15 is composed of a cathode material that has a columnar microstructure having columnar grain boundaries, CGB.

The various components of the solid-state batteries shown in FIGS. 1 and 2 are now described in greater detail along with a method(s) of making such batteries.

The substrate 10 that can be employed in the present application includes any conventional material that is used as a substrate for a solid-state rechargeable battery. In one embodiment, the substrate 10 may include one or more semiconductor materials. The term “semiconductor material” is used throughout the present application to denote a material having semiconducting properties. Examples of semiconductor materials that may be employed as substrate 10 include silicon (Si), germanium (Ge), silicon germanium alloys (SiGe), silicon carbide (SiC), silicon germanium carbide (SiGeC), III-V compound semiconductors or II-VI compound semiconductors. III-V compound semiconductors are materials that include at least one element from Group III of the Periodic Table of Elements and at least one element from Group V of the Periodic Table of Elements. II-VI compound semiconductors are materials that include at least one element from Group II of the Periodic Table of Elements and at least one element from Group VI of the Periodic Table of Elements.

In one embodiment, the semiconductor material that may provide substrate 10 is a bulk semiconductor substrate. By “bulk” it is meant that the substrate 10 is entirely composed of at least one semiconductor material, as defined above. In one example, the substrate 10 may be entirely composed of silicon. In some embodiments, the bulk semiconductor substrate may include a multilayered semiconductor material stack including at least two different semiconductor materials, as defined above. In one example, the multilayered semiconductor material stack may comprise, in any order, a stack of Si and a silicon germanium alloy.

In another embodiment, substrate 10 is composed of a topmost semiconductor material layer of a semiconductor-on-insulator (SOI) substrate. The SOI substrate would also include a handle substrate (not shown) including one of the above mentioned semiconductor materials, and an insulator layer (not shown) such as a buried oxide below the topmost semiconductor material layer.

In any of the embodiments mentioned above, the semiconductor material that may provide the substrate 10 may be a single crystalline semiconductor material. The semiconductor material that may provide the substrate 10 may have any of the well known crystal orientations. For example, the crystal orientation of the semiconductor material that may provide substrate 10 may be {100}, {110}, or {111}. Other crystallographic orientations besides those specifically mentioned can also be used in the present application.

In another embodiment, the substrate 10 is a metallic material such as, for example, aluminum (Al), aluminum alloy, titanium (Ti), tantalum (Ta), tungsten (W), or molybdenum (Mo).

In yet another embodiment, the substrate 10 is a dielectric material such as, for example, doped or non-doped silicate glass, silicon dioxide, or silicon nitride. In yet a further embodiment, the substrate 10 is composed of a polymer or flexible substrate material such as, for example, a polyimide, a polyether ketone (PEEK) or a transparent conductive polyester. In yet an even further embodiment, the substrate 10 may be composed of a multilayered stack of at least two of the above mentioned substrate materials, e.g., a stack of silicon and silicon dioxide.

In some embodiments, the substrate 10 may have a non-textured (flat or planar) surface. The term “non-textured surface” denotes a surface that is smooth and has a surface roughness on the order of less than 100 nm root mean square as measured by profilometry or atomic force microscopy (AFM). In yet another embodiment, the substrate 10 may have a textured surface. In such an embodiment, the surface roughness of the textured substrate can be in a range from 100 nm root mean square to 100 μm root mean square as also measured by profilometry or atomic force microscopy (AFM). Texturing can be performed by forming a plurality of metallic masks (e.g., tin masks) on the surface of a non-textured substrate, etching the non-textured substrate utilizing the plurality of metallic masks, and removing the metallic masks from the non-textured surface of the substrate. In some embodiments, the textured surface of the substrate is composed of a plurality of pyramids. In yet another embodiment, the textured surface of the substrate is composed of a plurality of cones. The plurality of metallic masks may be formed by depositing a layer of a metallic material and then performing an anneal. During the anneal, the layer of metallic material melts and balls-ups such that de-wetting of the surface of substrate occurs.

The cathode current collector 12 that is located on a physically exposed surface of the substrate 10 may include any metallic electrode material such as, for example, titanium (Ti), platinum (Pt), nickel (Ni), copper (Cu) and titanium nitride (TiN). In one example, cathode current collector 12 includes a stack of, from bottom to top, titanium (Ti), platinum (Pt) and titanium (Ti). The cathode current collector electrode 12 may be formed utilizing a deposition process including, for example, chemical vapor deposition (CVD), plasma enhanced chemical vapor deposition (PECVD), evaporation, sputtering, or plating. The cathode current collector electrode 12 may have a thickness from 10 nm to 500 nm. Other thicknesses that are lesser than, or greater than, the aforementioned thickness values may also be used for the bottom electrode 12.

In one embodiment as is shown in FIG. 1, the cathode material layer 14 that is located on a physically exposed surface of the cathode current collector 12 is composed of any electrically conductive material that includes grains having a grain size of less than 100 nm, and a density of grain boundaries of 10¹⁰ cm⁻² or greater. In some embodiments, the grain size of the individual grains that constituent the cathode material layer 14 is from 1 nm to less than 100 nm. In some embodiments, the density of boundaries can be from 10¹⁰ cm⁻² to 10¹⁴ cm ⁻². The term “grain boundary” is defined herein as an interface between two grains of materials. The grain boundaries, GBs, are present in the cathode material layer 14 in a somewhat random orientation. Some of the grain boundaries, GBs, may extend completely through the cathode material layer 14 such that one end of the grain boundary, GB, is present at a bottommost surface of the cathode material layer 14, and another end of the grain boundary, GB, is located at a topmost surface of the cathode material layer 14. In this embodiment, the grain boundaries are not oriented perpendicular to the topmost and bottommost surface of the cathode material layer 14.

In the embodiment shown in FIG. 2, the cathode material layer 15 that is located on a physically exposed surface of the cathode current collector 12 is composed of any electrically conductive material that has a columnar microstructure having columnar grain boundaries, CGBs. The columnar grain boundaries, CGBs, are oriented perpendicular to the topmost surface and the bottommost surface of the cathode material layer 15. In such an embodiment, the cathode material layer 15 has a fin-like structure as is shown in FIG. 2. The cathode material layer 15 having the columnar microstructure has a grain size of less than 100 nm, and a density of columnar grain boundaries of 10¹⁰ cm⁻² or greater. In some embodiments, the grain size of the individual grains that constituent the cathode material layer 15 is from 1 nm to less than 100 nm. In some embodiments, the density of columnar grain boundaries can be from 10¹⁰ cm⁻² to 10¹⁴ cm ⁻².

The presence of either the cathode material layer 14 or 15 within a solid-state battery provides fast and substantially or entirely vertical ion, i.e. Li ion, transport which can lead to fast charging batteries. Solid-state rechargeable batteries that contain cathode material layer 14 or 15 of the present application exhibit a charge rate of 5 C or greater, wherein C is the total battery capacity per hour. In some embodiments, the charge rate of the solid-state batteries of the present application can be from 5 C to 1000 C or greater. In other embodiments, the charge rate of the solid-state batteries of the present application can be from 10 C or greater. Also, the solid-state batteries of the present application have a capacity of 50 mAh/gm of cathode material or greater, with a capacity of 50 mAh/gm to 120 mAh/gm being a typical range.

In one embodiment of the present application, the cathode material layer 14 or 15 is a lithiated material such as, for example, a lithium-based mixed oxide. Examples of lithium-based mixed oxides that may be employed as include, but are not limited to, lithium cobalt oxide (LiCoO₂), lithium nickel oxide (LiNiO₂), lithium manganese oxide (LiMn₂O₄), lithium cobalt manganese oxide (LiCoMnO₄), a lithium nickel manganese cobalt oxide (LiNiₓMn_{y}Co_{z}O₂), lithium vanadium pentoxide (LiV₂O₅) or lithium iron phosphate (LiFePO₄).

The cathode material layer 14 or 15 may be formed utilizing a sputtering process. In some embodiments, and following the sputtering of the cathode material, no subsequent anneal is performed; the cathode material that is sputtered without annealing provides cathode material layer 14 mentioned above. In other embodiments, and following the sputtering of the cathode material, an anneal may be performed to provide cathode material layer 15 mentioned above. Annealing is performed at a temperatures less than 300° C. to preserve the charge rate of greater 5 C. In one embodiment, sputtering may include the use of any precursor source material or combination of precursor source materials. In one example, a lithium precursor source material and a cobalt precursor source material are employed in forming a lithium cobalt mixed oxide. Sputtering may be performed in an admixture of an inert gas and oxygen. In such an embodiment, the oxygen content of the inert gas/oxygen admixture can be from 0.1 atomic percent to 70 atomic percent, the remainder of the admixture includes the inert gas. Examples of inert gases that may be used include argon, helium, neon, nitrogen or any combination thereof.

The cathode material layer 14 or 15 may have a thickness from 10 nm to 20 μm. Other thicknesses that are lesser than, or greater than, the aforementioned thickness values may also be used for the cathode material layer 14 or 15. Thick cathode material layers 14 or 15 can provide enhanced battery capacity since there is more area, i.e., volume, to store the battery charge.

The solid-state electrolyte 16 that is located on the cathode material layer 14 or 15 may include any conventional polymer based electrolyte material or an inorganic electrolyte material. The electrolyte material may be a lithiated electrolyte material or a non-lithiated electrolyte material. Examples of polymer based solid-state electrolyte materials include, but are not limited to, poly (ethylene oxide), poly (propylene oxide), polyphosphazene, and polysiloxane mixed with Li salts. Examples of inorganic solid-state electrolyte materials include, but are not limited to, lithium phosphorus oxynitride (LiPON) or lithium phosphosilicate oxynitride (LiSiPON). Such materials enable the conduction of lithium ions and can be electrically insulating, but ionic conducting.

The solid-state electrolyte 16 may be formed utilizing a deposition process such as, sputtering, solution deposition or plating. In one embodiment, the solid-state electrolyte 16 is formed by sputtering utilizing any conventional precursor source material. Sputtering may be performed in the presence of at least a nitrogen-containing ambient. Examples of nitrogen-containing ambients that can be employed include, but are not limited to, N₂, NH₃, NH₄, NO, or NHₓ wherein x is between 0 and 1. Mixtures of the aforementioned nitrogen-containing ambients can also be employed. In some embodiments, the nitrogen-containing ambient is used neat, i.e., non-diluted. In other embodiments, the nitrogen-containing ambient can be diluted with an inert gas such as, for example, helium (He), neon (Ne), argon (Ar) and mixtures thereof. The content of nitrogen (N₂) within the nitrogen-containing ambient employed is typically from 10% to 100%, with a nitrogen content within the ambient from 50% to 100% being more typical.

In some embodiments, a lithium nucleation enhancement liner such as disclosed, for example, in co-pending and co-assigned U.S. Ser. No. 15/474,668, filed on Mar. 30, 2017, the entire content and disclosure of which is incorporated herein by reference, can be formed atop the solid-state electrolyte 16. When employed, the lithium nucleation enhancement liner comprises gold (Au), silver (Ag), zinc (Zn), magnesium (Mg), tantalum (Ta), tungsten (W), molybdenum (Mo), titanium-zirconium-molybdenum alloy (TZM), or silicon (Si).

The anode region 18 may include any conventional anode material that is found in a rechargeable battery. In some embodiments, the anode region 18 is composed of a lithium metal, a lithium-base alloy such as, for example, LiₓSi, or a lithium-based mixed oxide such as, for example, lithium titanium oxide (Li₂TiO₃). The anode region 18 may also be composed of Si, graphite, or amorphous carbon.

In some embodiments, the anode region 18 is formed prior to performing a charging/recharging process. In such an embodiment, the anode region 18 can be formed utilizing a deposition process such as, for example, chemical vapor deposition (CVD), plasma enhanced chemical vapor deposition (PECVD), evaporation, sputtering or plating. In some embodiments, the anode region 18 is a lithium accumulation region that is formed during charging/recharging. The lithium accumulation region can be continuous or discontinuous directly above the electrolyte. The anode region 18 may have a thickness of 10 nm or greater if it is formed during charging/discharging. For a deposited anode or a sheet of anode material, such as a lithium metal, the thickness can vary from 10 nm to 500 μm.

The anode current collector 20 (anode-side electrode) may include any metallic electrode material such as, for example, titanium (Ti), platinum (Pt), nickel (Ni), copper (Cu) or titanium nitride (TiN). In one example, the anode current collector 20 includes a stack of, from bottom to top, nickel (Ni) and copper (Cu). In one embodiment, the metallic electrode material that provides the anode current collector 20 may be the same as the metallic electrode material that provides the cathode current collector 12. In another embodiment, the metallic electrode material that provides the anode current collector 20 may be different from the metallic electrode material that provides the cathode current collector 12. The anode current collector 20 may be formed utilizing a deposition process such as, for example, chemical vapor deposition, sputtering or plating. The anode current collector 20 may have a thickness from 50 nm to 200 μm.

The cathode material layer 14 or 15, the solid-state electrolyte 16, the anode region 18, and the anode current collector 20 typically have sidewall surfaces that are vertically aligned to each other. In some embodiments, and as is shown in FIG. 1 or 2, the sidewall surfaces of the cathode material layer 14 or 15, the solid-state electrolyte 16, the anode region 18, and the anode current collector 20 are not vertically aligned with the sidewall surfaces of the cathode current collector 12 and the substrate 10. In other embodiments (not shown), the sidewall surfaces of the cathode material layer 14 or 15, the solid-state electrolyte 16, the anode region 18, and the anode current collector 20 are also vertically aligned with the sidewall surfaces of at least the cathode current collector 12.

In some embodiments, and as is shown in FIGS. 1 and 2, a passivation layer 22 is present. The passivation layer 22 includes any air and/or moisture impermeable material or multilayered stack of such materials. Examples of air and/or moisture impermeable materials that can be employed in the present application include, but are not limited to, parylene, a fluoropolymer, silicon nitride, and/or silicon dioxide. The passivation layer 22 may be formed by first depositing the air and/or moisture impermeable material and thereafter patterning the air and/or moisture impermeable material. In one embodiment, patterning may be performed by lithography and etching.

The solid-state rechargeable battery of the present application can be formed utilizing conventional methods known to those skilled in the art. In one example, the solid-state rechargeable battery can be formed by blanket deposition of a battery material stack of the cathode current collector 12, the cathode material layer 14 or 15, the solid-state electrolyte 16, optionally the anode region 18, and the anode current collector 20 on a physically exposed surface of the substrate 10. In some embodiments, the cathode material layer 14 or 15, the solid-state electrolyte 16, the optional anode region 18, and the anode current collector 20 can then be patterned by lithography and etching and thereafter the passivation layer 22 can be formed surrounding the patterned battery material stack. In such an embodiment, the passivation layer 22 can be located on each of the sidewall surfaces of the cathode material layer 14 or 15, the solid-state electrolyte 16, the optional anode region 18, and the anode current collector 20. Also, and as shown in FIGS. 1 and 2, an upper portion of each passivation layer 22 extends onto a topmost surface of the anode current collector 20, and a lower portion of each passivation layer 22 is located on a physically exposed portion of the cathode current collector 12.

In some embodiments the method such as described, for example, in co-pending and co-assigned U.S. Ser. No. 15/474,570, filed on Mar. 30, 2017, the entire content and disclosure of which is incorporated herein by reference, can be employed in forming the battery. Notably, such a method includes first blanket depositing the cathode current collector 12 on the substrate 10 and then a patterned mask (not shown) can be formed on a portion of the cathode current collector 12. In this embodiment, the patterned sacrificial material includes at least one opening that physically exposes at least one portion of cathode current collector 12. The patterned sacrificial material can be formed by first applying a sacrificial material (not shown) to a physically exposed surface of the cathode current collector 12. In one embodiment, the sacrificial material is a photoresist material. In such an embodiment, the photoresist material may be a positive-tone photoresist material, a negative-tone photoresist material or a hybrid-tone photoresist material. The sacrificial material may be formed utilizing a deposition process such as, for example, chemical vapor deposition (CVD), plasma enhanced chemical vapor deposition (PECVD) or spin-on coating. The sacrificial material may have a thickness from 100 nm to 20 μm. Other thicknesses that are lesser than, or greater than, the aforementioned thickness values may also be used for the sacrificial material.

The deposited sacrificial material is then patterned. In one embodiment and when the sacrificial material is a photoresist material, the photoresist material may be patterned by exposing the photoresist material to a desired pattern of radiation, and thereafter the exposed photoresist material is developed utilizing a conventional resist developer to provide a patterned sacrificial material. When non-photoresist sacrificial materials are used, the non-photoresist sacrificial materials can be patterned by lithography and etching.

The patterned sacrificial material can be formed by first attaching a sacrificial material (not shown) to the physically exposed surface of the cathode current collector 12. In one embodiment, the sacrificial material is a shadow mask. In such an embodiment, the shadow mask may be a pre-patterned metallic material or a pre-patterned polymer material. The pre-patterned shadow mask material is attached to the substrate by mechanical force or removable adhesive.

After forming the patterned sacrificial material, blanket layers of the cathode material layer 14 or 15, solid-state electrolyte 16, optionally the anode region 18, and the anode current collector 20 are formed and then a lift-off process is performed that removes all the material that is present atop the patterned sacrificial material layer. The lift-off process includes removing the patterned sacrificial material utilizing a solvent or etchant that is selective for removing the sacrificial material. When patterned sacrificial material is removed, the materials on the top of the patterned sacrificial material are also removed from the structure. As mentioned above, and in some embodiments, charging/recharging can be performed to form the anode region 18.

The solid-state rechargeable battery of the present application as exemplified in FIGS. 1 and 2 (with or without the anode region 18) can be subjected to a charge method. When no anode region 18 is intentionally deposited, the charging forms an anode region 18, i.e., lithium accumulation region (continuous or discontinuous). The charge method may be performed utilizing conventional charging techniques well known to those skilled in the art. For example, the charge method may be performed by connecting the solid-state rechargeable battery of the present application to an external power supply and supply current or a voltage to the battery. In such charging/recharging method, a constant current is used until a maximum voltage is reached. In some embodiments, the charging method disclosed in co-pending and co-assigned U.S. Ser. No. 15/474,640, filed on Mar. 30, 2017, the entire content and disclosure of which is incorporated herein by reference, may be employed to charge the battery of the present application.

In other embodiments, a two stage charge method can be used. In one embodiment, the two stage charge method includes first charging at a constant current (or increasing voltage) until a threshold voltage is reached. Next, second charging is performed at a constant voltage (or decreasing current) until the charging current falls below a threshold current.

It is again noted that the presence of either the cathode material layer 14 or 15 within a solid-state battery as shown, for example, in FIGS. 1 and 2, provides fast and substantially or entirely vertical ion, i.e. Li ion, transport which can lead to a fast charging battery having a charge rate of 5 C or greater, or preferably from 10 C or greater.

In any of the embodiments of the present application, the cathode material layer 20 may contain a nitrogen-enriched lithiated cathode material surface layer such as is disclosed, for example, in U.S. Ser. No. 15/675,296, filed on Aug. 11, 2017, the entire content and disclosure of which is incorporated herein by reference. Also, the batteries of the present application may be stacked one atop the other, or include an array of interconnected solid-state thin-film batteries, or contain a solid-state thin-film battery located on physically exposed surfaces of fin (i.e., pillar) structures, as are disclosed in U.S. Ser. No. 15/481,042, filed Apr. 6, 2017, the entire content and disclosure of which is incorporated herein by reference.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A solid-state rechargeable battery comprising:
a cathode current collector;
a cathode material layer located on a physically exposed surface of the cathode current collector and comprising grains having a grain size of less than 100 nm and a density of grain boundaries of 10¹⁰ cm⁻² or greater;
a solid-state electrolyte located on a physically exposed surface of the cathode material layer;
an anode region located on the solid-state electrolyte; and
an anode current collector located on the anode region.

2. The solid-state rechargeable battery of claim 1, wherein the grain size is from 1 nm to less than 100 nm.

3. The solid-state rechargeable battery of claim 1, wherein the density of grain boundaries is from 10¹⁰ cm⁻² to 10¹⁴ cm⁻².

4. The solid-state rechargeable battery of claim 1, wherein the cathode material layer is a lithiated cathode material.

5. The solid-state rechargeable battery of claim 1, further comprising a substrate located directly beneath the cathode current collector.

6. The solid-state rechargeable battery of claim 1, wherein the rechargeable battery has a capacity of 50 mAh/gm or greater.

7. The solid-state rechargeable battery of claim 1, wherein the solid-state electrolyte is composed of a lithiated material.

8. The solid-state rechargeable battery of claim 1, wherein the solid-state electrolyte is composed of a non-lithiated material.

9. The solid-state rechargeable battery of claim 1, wherein the cathode material layer, the solid-state electrolyte, the anode region, and the anode current collector have sidewall surfaces that are vertically aligned to each other.

10. The solid-state rechargeable battery of claim 9, further comprising a passivation layer located on each of the sidewall surfaces of the cathode material layer, the solid-state electrolyte, the anode region, and the anode current collector, wherein an upper portion of each passivation layer extends onto a topmost surface of the anode current collector, and a lower portion of each passivation layer is located on a physically exposed portion of the cathode current collector.

11. The solid-state rechargeable battery of claim 1, wherein the solid-state rechargeable battery has a charge rate of 5 C or greater.

12. A solid-state rechargeable battery comprising:
a cathode current collector;
a cathode material layer located on a physically exposed surface of the cathode current collector and comprising a columnar microstructure;
a solid-state electrolyte located on a physically exposed surface of the cathode material layer;
an anode region located on the solid-state electrolyte; and
an anode current collector located on the anode region.

13. The solid-state rechargeable battery of claim 12, wherein the columnar microstructure comprises columnar grain boundaries.

14. The solid-state rechargeable battery of claim 13, wherein the columnar microstructure comprises grains having a grain size of less than 100 nm and a density of columnar grain boundaries of 10¹⁰ cm⁻² or greater.

15. The solid-state rechargeable battery of claim 14, wherein the grain size is from 1 nm to less than 100 nm.

16. The solid-state rechargeable battery of claim 14, wherein the density of columnar grain boundaries is from 10¹⁰ cm⁻²to 10¹⁴ cm⁻².

17. The solid-state rechargeable battery of claim 12, wherein the cathode material layer is a lithiated cathode material.

18. The solid-state rechargeable battery of claim 12, further comprising a substrate located directly beneath the cathode current collector.

19. The solid-state rechargeable battery of claim 12, wherein the rechargeable battery has a capacity of 50 mAh/gm or greater.

20. The solid-state rechargeable battery of claim 12, wherein the solid-state electrolyte is composed of a lithiated material.

21. The solid-state rechargeable battery of claim 12, wherein the solid-state electrolyte is composed of a non-lithiated material.

22. The solid-state rechargeable battery of claim 12, wherein the cathode material layer, the solid-state electrolyte, the anode region, and the anode current collector have sidewall surfaces that are vertically aligned to each other.

23. The solid-state rechargeable battery of claim 12, further comprising a passivation layer located on each of the sidewall surfaces of the cathode material layer, the solid-state electrolyte, the anode region, and the anode current collector, wherein an upper portion of each passivation layer extends onto a topmost surface of the anode current collector, and a lower portion of each passivation layer is located on a physically exposed portion of the cathode current collector.

24. The solid-state rechargeable battery of claim 12, wherein the solid-state rechargeable battery has a charge rate of 5 C or greater.
